(19) United States
(12) Patent Application Publication
(10) Pub. No.: US 2026/0153193 A1
(43) Pub. Date: Jun. 4, 2026

(54) PORTABLE, MODULAR AIR DELIVERY SYSTEM FOR SELF-CONTAINED BREATHING APPARATUS REFILLING

(71) Applicant: Special Projects Operations, Inc., Belcamp, MD (US)

(72) Inventors: Trey Dunavent, Shiloh, NC (US); Parker Wood, Virginia Beach, VA (US)

(21) Appl. No.: 19/407,431

(22) Filed: Dec. 3, 2025

Related U.S. Application Data
(60) Provisional application No. 63/727,545, filed on Dec. 3, 2024.

(51) Int. Cl. F17C 5/06

(52) U.S. Cl. CPC F17C 5/06; F17C 2201/0104; F17C 2205/0111; F17C 2221/031; F17C 2223/036; F17C 2227/0157; F17C 2270/025

(57) ABSTRACT

A portable, modular air delivery system for refilling self-contained breathing apparatus (SCBA) cylinders under adverse field conditions includes a ruggedized enclosure housing a four-stage breathing air compressor with interstage cooling driven by a diesel engine, modular air storage cylinders rated to 6,000 psi, and a distribution manifold with four high-pressure outlets for simultaneous refilling operations. The compressor provides dual-pressure outputs for SCBA refilling and pneumatic tool operation. An extended-length hose system enables cylinder refilling at distances up to 500 feet. The system performs cascade filling operations and features dual rolling door assemblies for bilateral access. Weatherproofed components enable operation during rain while maintaining Grade D breathing air quality. Connector fittings accommodate US military and Israeli SCBA standards. Modular construction permits component removal from a mobile trailer platform for redistribution. The system meets 463L pallet constraints and achieves fill times under 5 minutes.

### CROSS-REFERENCE TO RELATED APPLICATIONS

This application claims priority to U.S. Provisional Patent Application No. 63/727,545, filed Dec. 3, 2024 and titled “Portable, Modular Air Delivery System,” the specification of which is incorporated herein by reference in its entirety.

### FIELD OF THE INVENTION

The present invention relates generally to portable air compression and distribution systems, and more particularly to a mobile, modular air delivery system configured for rapid refilling of self-contained breathing apparatus (SCBA) cylinders under adverse weather conditions and on uneven terrain in field environments.

### BACKGROUND

Various emergency personnel, including first responders, military units, law enforcement agencies, and specialized tactical teams frequently conduct operations in tunnels, underground facilities, confined spaces, and other environments where the atmosphere may be hazardous, contaminated, or oxygen-deficient. Such environments require the use of life support equipment, particularly individual supplied air respirators or self-contained breathing apparatuses. Conducting operations in these challenging environments requires units to plan for and provide life-sustaining refill and recharge services to operators'life support equipment under all adverse weather conditions and terrain configurations that may be encountered during deployment.

Individual SCBAs have limited operating time based on the capacity of their compressed air cylinders and the breathing rate of the user, typically ranging from 30 to 60 minutes under normal working conditions. These systems must be rapidly recharged with clean, compressed breathing air to provide sustained life support during extended operations. Without reliable refilling capability, operational missions must be curtailed or personnel must be rotated frequently, significantly reducing mission effectiveness and time-on-target.

Current systems used to refill respirator air bottles in field environments suffer from significant limitations in durability, dependability, and operational flexibility. Existing field refilling systems are highly susceptible to malfunction if operated outside of narrowly defined ideal conditions. When operated in rain, precipitation, or high-humidity environments, these systems have the potential to introduce moisture contamination into individual SCBA cylinders, which can cause significant harm to an operator's respiratory system including pulmonary edema and other serious medical conditions. The risk of moisture contamination forces operational planners to restrict the timing of subterranean and confined space operations based on favorable weather forecasts, significantly limiting tactical flexibility.

Additionally, current refilling systems are susceptible to malfunction when not positioned on perfectly level surfaces. Many existing compressor systems require precise leveling to ensure proper lubrication oil distribution within the compressor mechanism. Uneven terrain, which is frequently encountered in austere field conditions, operational staging areas, and forward deployment locations, can cause improper oil flow leading to inadequate lubrication, excessive wear, overheating, and catastrophic compressor failure.

Furthermore, existing systems experience significant pressure drop when hoses are extended to refill air bottles at distances from the refill station location. This pressure loss renders conventional systems incapable of filling SCBA air cylinders to the required operating pressure of 6,000 pounds per square inch (psi) when personnel must work at extended distances from the compressor location. This limitation forces personnel to remain in close proximity to the refilling equipment, which may not be tactically sound or operationally feasible in many deployment scenarios.

Current systems also lack modularity, being configured as integrated units that cannot be disassembled for transport in multiple vehicles or via aircraft. The inability to separate components limits deployment options and increases the logistical burden of transportation, particularly for air insertion operations with weight and volume constraints.

There exists a need in the art for an improved portable air delivery system that overcomes these limitations by providing reliable SCBA refilling capability regardless of weather conditions, terrain configuration, or distance from the compressor to the point of use, while maintaining a modular design that facilitates flexible deployment and transportation options.

### SUMMARY OF THE INVENTION

In accordance with certain aspects of an embodiment, the present invention addresses the deficiencies of prior art SCBA refilling systems by providing a portable, modular air delivery system specifically configured for rapid refill and recharge of life support systems with up to 6,000 pounds per square inch of breathable air without regard to weather conditions, terrain levelness, or distance of the air compression unit from the life support equipment requiring service.

In one aspect of an exemplary embodiment, a portable air delivery system comprises an enclosure assembly defining an interior volume, a four-stage breathing air compressor with interstage cooling disposed within the interior volume, a diesel engine operatively connected to drive the compressor, modular air storage cylinders configured to store compressed breathing air at pressures up to approximately 6,000 psi, a distribution manifold having multiple high-pressure outlet connections configured for simultaneous refilling of multiple SCBA cylinders, and an extended-length hose reel system configured to deliver compressed air at distances up to at least 500 feet from the system. The compressor is configured to provide dual-pressure outputs including high-pressure output at approximately 6,000 psi for SCBA cylinder refilling and low-pressure output at approximately 300 psi for operation of pneumatic tools and rescue equipment. The enclosure assembly is configured with weather-resistant features including weatherproofed electrical components, an improved ingress protection rating, and a weatherproofed compressor intake system to enable operation during rain, water spray, and dripping water conditions while maintaining breathing air quality standards.

In another aspect of an exemplary embodiment, the system includes a mobile trailer platform having a hitch assembly compatible with standard military vehicles, wherein the enclosure assembly, compressor, engine, and storage cylinders are removably mounted to the trailer platform in a modular configuration such that individual components can be removed from the trailer and redistributed among other vehicles while retaining operational capability when reassembled without the trailer platform present. The enclosure assembly includes dual rolling door assemblies positioned on opposite side walls to provide bilateral access to internal components for maintenance and operational activities from either side of the system.

In a further aspect, a leveling system is provided that is configured to aid in setup and staging of the compressor assembly on uneven terrain, wherein the compressor is capable of operating on grades of at least 36.4 percent while maintaining proper lubrication and operational parameters. The four-stage compression configuration includes interstage cooling between compression stages to improve compression efficiency and reduce thermal stress on compressor components.

In yet another aspect, the system is configured to meet Military Standard (MIL-STD) 810H requirements for operation in rain, spray, and dripping water; temperature shock and impact during air drop operations; transport over unimproved and off-road conditions; and function across cold, hot-dry, and hot-humid climactic condition profiles.

In a further aspect, the system is configured for cascade filling operations whereby compressed air stored in the modular air storage cylinders is transferred to self-contained breathing apparatus cylinders through the distribution manifold without continuous compressor operation during the transfer, enabling rapid flash fill capability.

In an additional aspect, the distribution manifold and extended-length hose are configured with connector fittings compatible with both United States military standard SCBA equipment and Israeli standard SCBA equipment to enable interoperability in combined operations and when supporting allied forces.

The system is preferably configured to provide air delivery at a rate of approximately 22.5 cubic feet per minute (CFM), corresponding to approximately 637 liters per minute, and to provide total air storage capacity of approximately 94 liters uncompressed volume, corresponding to approximately 31,351 liters at 6,000 psi. The system is configured to rapidly fill SCBA air cylinders in less than 5 minutes as a threshold requirement, with an objective fill time of approximately 1.5 minutes, and to accomplish such filling operations at distances up to at least 500 feet from the system staging area utilizing extension hoses.

These and other features and advantages of the invention will become apparent from the following detailed description of preferred embodiments.

### BRIEF DESCRIPTION OF THE DRAWINGS

The numerous advantages of the present invention may be better understood by those skilled in the art by reference to the accompanying drawings in which:

FIG. 1(a) is a left side perspective view of an AWAJ system in accordance with certain aspects of an embodiment of the invention.

FIG. 1(b) is a right side perspective view of the AWAJ system of FIG. 1(a).

FIG. 2 is a schematic view of a distribution manifold for use with the system of FIG. 1(a) and 1(b).

FIG. 3 is a perspective view of a hose reel system for use with the system of FIG. 1(a) and 1(b).

FIG. 4(a) is a front, left perspective view of the air compressor and diesel engine module for use in the system of FIG. 1(a) and 1(b).

FIG. 4(b) is a front, right perspective view of the air compressor and diesel engine module for use in the system of FIG. 1(a) and 1(b).

FIG. 4(c) is a front, right perspective view of the air compressor and diesel engine module and showing the placement of a control panel.

FIG. 4(d) is a front, right perspective view of portions of the air compressor and diesel engine module and showing details of the bottle rack assembly.

FIG. 4(e) is a back, left perspective view of portions of the air compressor and diesel engine module and showing details of the side walls and base plate.

FIG. 4(f) is a perspective view of the back wall of the air compressor and diesel engine module.

FIG. 4(g) is a perspective view of the front wall of the air compressor and diesel engine module.

FIG. 4(h) is a back, left perspective view of portions of the air compressor and diesel engine module and showing details of roof support system.

FIG. 4(i) is a front, right perspective view of portions of the air compressor and diesel engine module with side walls removed to show details of the compressor assembly.

FIG. 4(i) is a back, left perspective view of portions of the air compressor and diesel engine module with side walls removed to show details of the compressor and diesel engine assemblies.

FIG. 4(k) is a front, right side view of the air compressor and diesel engine module showing details of the roof assembly.

FIG. 5(a) is a back, right perspective view of the storage module for use in the system of FIG. 1(a) and 1(b).

FIG. 5(b) is a back, left perspective view of the storage module.

FIG. 5(c) is a front, right perspective view of the storage module.

FIG. 5(d) is a front, left perspective view of the storage module.

FIG. 5(e) is a front, right side view of the interior components of the storage module.

FIG. 5(f) is a back, left side view of the interior components of the storage module.

FIG. 5(g) is a back, left perspective view of portions of the storage module with side walls removed to show details of the bottle plumbing system.

### DETAILED DESCRIPTION

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

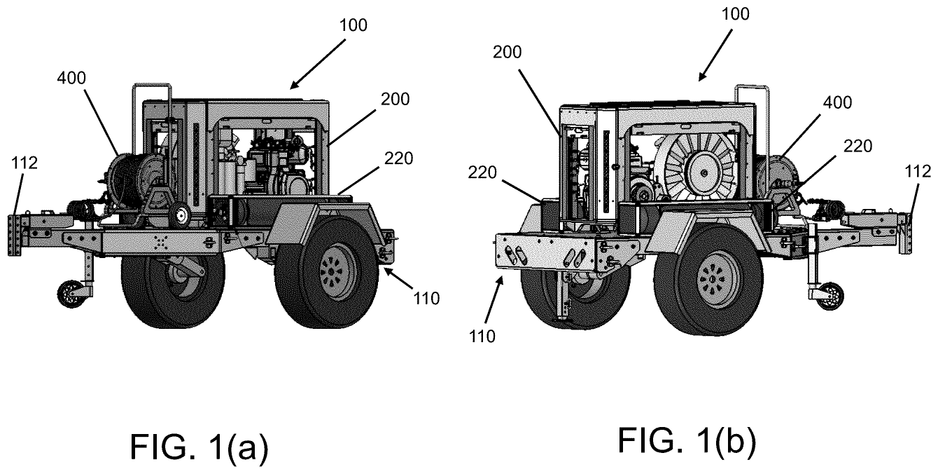

With particular reference to FIG. 1(a) and 1(b) and in accordance with certain aspects of an embodiment, disclosed herein is an All-Weather Air Jammer system, shown generally at 100 and referred to herein as AWAJ system 100, configured for rapid refill and recharge of life support systems with up to 6,000 pounds per square inch of breathable air without regard to weather conditions, terrain levelness, or distance of the air compression and storage system from the life support equipment requiring service. This improvement in operational capability dramatically improves flexibility in the timing of operational missions and increases available dwell time-on-target for personnel conducting operations in hazardous atmosphere environments. The AWAJ system 100 comprises a mobile trailer platform 110, an air compressor and diesel engine module 200, a storage assembly 500, a distribution manifold 300, and a hose reel system 400, all configured to work cooperatively to provide sustained SCBA refilling operations in austere field environments.

The mobile trailer platform 110 provides the foundational transport and mounting structure for the major system components and includes a hitch assembly 112 configured for connection to towing vehicles. The hitch assembly 112 is preferably a pintle-style receiver hitch compatible with United States military tactical vehicles including but not limited to HMMWV, JLTV, and various truck platforms. The hitch assembly 112 and associated electrical wire harness are compatible with standard United States vehicles, providing full interoperability with existing equipment inventories. The trailer platform 110 is designed as an ultra-lightweight trailer, referred to as ULT, specifically configured to minimize weight while providing structural strength sufficient for off-road transport and air drop operations. The trailer platform 110 incorporates a ruggedized trailer frame designed for mobility and transportability over uneven terrain and unimproved road surfaces commonly encountered in field deployment environments. A trailer jack is provided for supporting the forward end of the trailer platform 110 when disconnected from a towing vehicle. Support legs are provided in a stowable configuration for transport and are deployable to provide additional stability during stationary operation. The trailer platform 110 is designed for transport on a pallet or trailer having dimensions not exceeding 180 inches in width by 88 inches in length, and the AWAJ system 100 is preferably configured such that the weight and volume of the entire system does not exceed the cargo capacity of one 463L Master Pallet, which is the standard pallet configuration for loading in fixed-wing cargo aircraft or rotary-wing heavy-lift helicopters. The total system weight does not exceed 10,000 pounds, thereby maintaining compatibility with standard air transport platforms and vehicle towing capacity limitations.

A critical feature of the AWAJ system 100 is its modular design implemented throughout the system to allow removal of substantially all system components required for air compression and distribution operations from the mobile trailer platform 110 so that components may be redistributed among other tactical vehicles or transport platforms, thereby saving critical cargo space on deploying aircraft or in vehicle convoys with limited capacity. These system components are capable of being reassembled and operated without the trailer platform 110 being present, providing maximum operational flexibility. By way of example, the air compressor and diesel engine module 200 may be removed from the trailer platform 110 at the operator level without requiring specialized lifting equipment or extensive technical expertise. Similarly, the storage assembly 500 is configured as a separate modular unit removable from the trailer platform 110 for redistribution to other vehicles or transport platforms. The stackable modular storage cylinder modules can be stacked and configured as desired based on available space and capacity requirements, with securing mechanisms to prevent shifting during transport. This modularity provides significant operational advantages including the ability to transport components separately when cargo space is limited, the ability to redistribute components among multiple vehicles to balance loads or provide redundancy, the ability to operate the system without the trailer when ground conditions make wheeled transport impractical, and the ability to scale system capacity by adding or removing storage cylinders based on mission requirements.

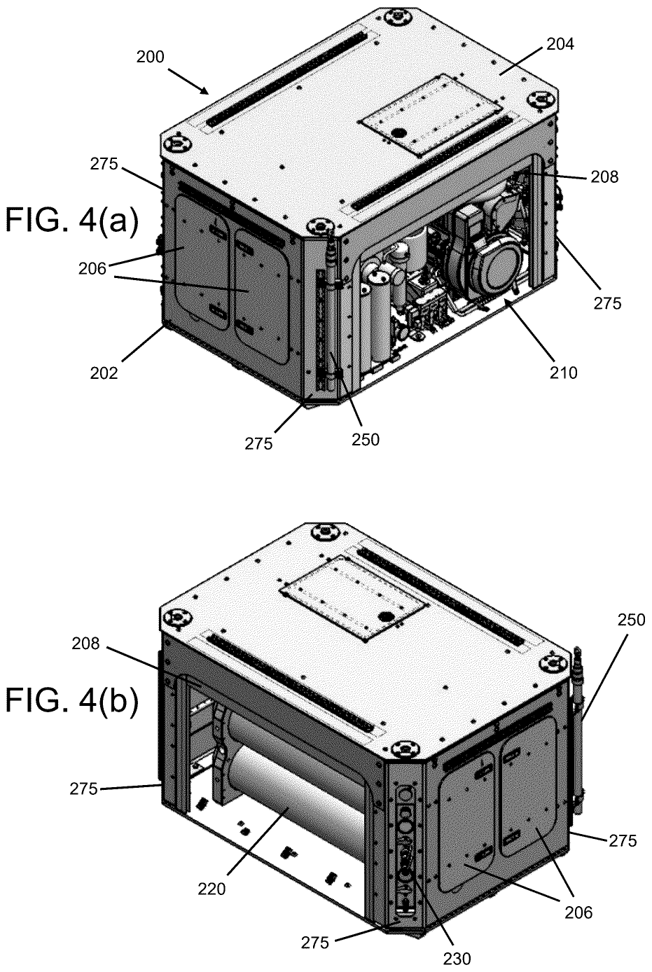

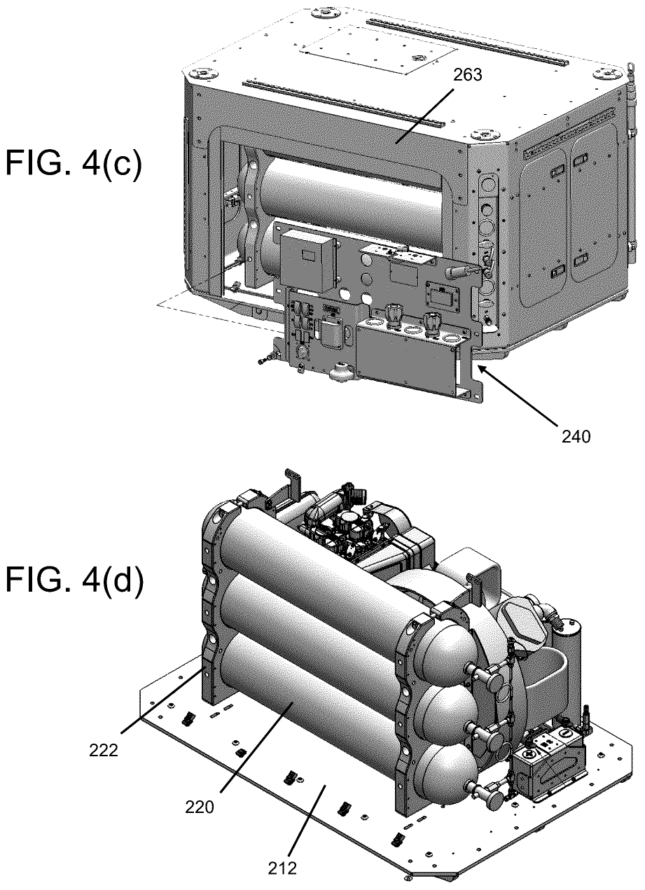

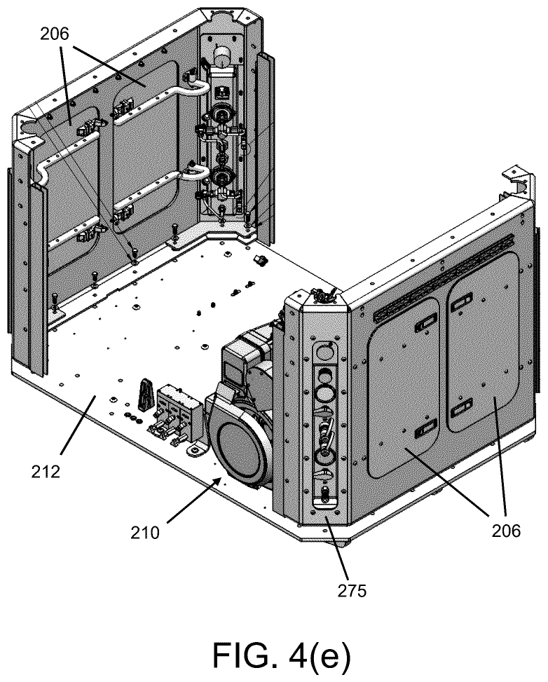

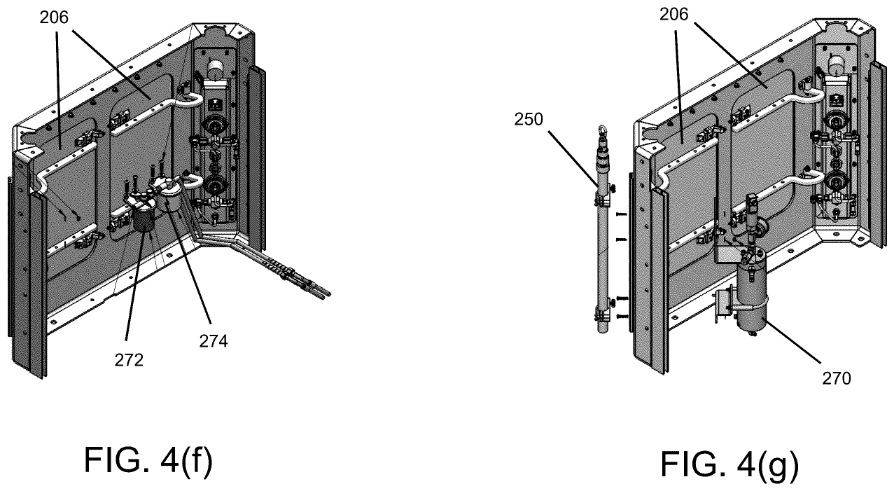

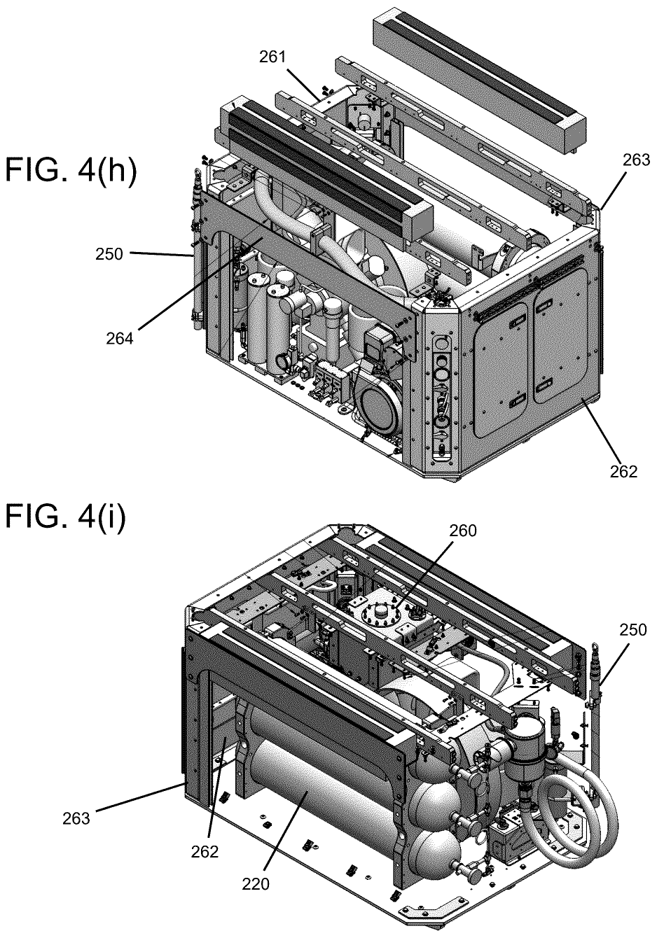

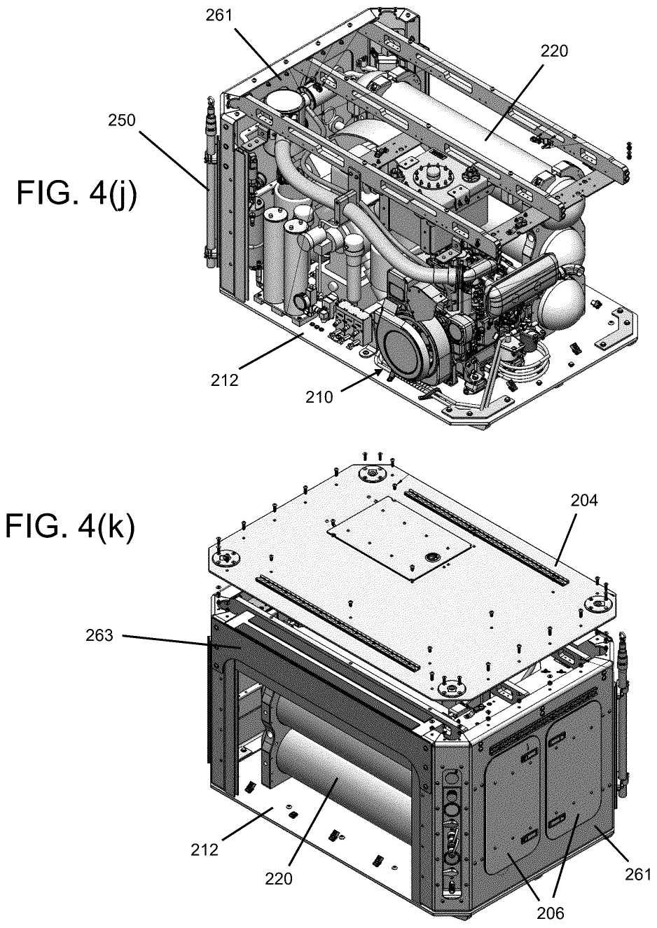

With particular reference to FIG. 4(a) through 4(k), the air compressor and diesel engine module 200 forms the core operational unit of the AWAJ system 100 and comprises a pod enclosure 202 housing the compressor, diesel engine 210, and associated operational components. The pod enclosure 202 is mounted on and removable from the towable trailer platform 110 and defines an interior volume within which the primary compression and power generation equipment is disposed. The pod enclosure 202 includes a base plate 212 providing structural foundation and mounting interface to the trailer platform 110. The base plate 212 is configured with sufficient structural rigidity to support the weight of the diesel engine 210, compressor assembly, and all associated components while withstanding the dynamic loads encountered during transport over unimproved roads and off-road terrain. The pod enclosure 202 further comprises a first end wall 261 and a second end wall 262 positioned at opposite ends of the module, and a first side wall 263 and a second side wall 264 positioned at opposite sides of the module. The end walls 261, 262 and side walls 263, 264 cooperate with the base plate 212 and a roof assembly 265 to form the complete enclosed structure of the pod enclosure 202. Corner plates 275 are provided at the corners of the pod enclosure 202 to provide structural reinforcement and ensure structural integrity during handling, transport, and operational use.

The pod enclosure 202 includes an upper surface 204 configured to support certain components and provide access features. Access panels 206 are provided at strategic locations on the pod enclosure 202 to facilitate inspection, routine maintenance, and field repair activities without requiring extensive disassembly of the module. Rolling doors 208, preferably roll-up doors sometimes referred to as rollok doors, are provided on the pod enclosure 202 to assist in operation, routine maintenance, and field repair activities by providing generous access to internal components without requiring extensive disassembly. The rolling doors 208 are incorporated as dual rolling door assemblies positioned on opposite sides of the enclosure to provide generous access to internal components from either side of the unit. This bilateral access facilitates maintenance, component replacement, and operational activities regardless of how the unit is positioned relative to available working space. Rolling door housings contain the mechanisms for the rolling doors 208, allowing the doors to be easily opened and securely closed.

The roof assembly 265 provides weather protection and structural integrity for the pod enclosure 202. Top plate stiffeners provide additional structural support across the roof span to prevent deflection and maintain structural rigidity under load. The roof assembly 265 cooperates with the other enclosure elements to protect internal components from precipitation, wind-blown debris, and other environmental hazards. The entire pod enclosure 202 is configured with weatherproofing features to enable operation during rain, water spray, and dripping water conditions while maintaining breathing air quality standards. The enclosure is configured with an improved ingress protection rating, preferably meeting IP65 or better standards, to prevent water intrusion into critical mechanical and electrical systems. The system incorporates an integrated canopy or cover structure that protects critical components from direct precipitation exposure. Electrical components are specifically configured for weatherproofing, including sealed connectors, protected wiring routing, and moisture-resistant control panels.

Disposed within the interior volume of the pod enclosure 202 is a diesel engine 210, preferably a direct-injection diesel engine, selected for reliability, fuel efficiency, and operational capability across a wide range of environmental conditions. The diesel engine 210 is selected to provide reliable starting and operation across the full temperature range from cold environments with temperatures below freezing to hot desert environments with temperatures exceeding 120 degrees Fahrenheit. The diesel engine 210 is equipped with appropriate filtration, cooling, and exhaust systems to ensure reliable operation and long service life. An engine air intake filter assembly is provided to filter ambient air supplied to the diesel engine 210 for combustion. The diesel engine 210 is operatively connected to drive a four-stage breathing air compressor disposed within the interior volume of the pod enclosure 202. The four-stage compression configuration provides efficient compression from atmospheric pressure to the final output pressure of 6,000 pounds per square inch while managing heat generation and maintaining acceptable discharge temperatures. Interstage cooling is provided between compression stages to improve efficiency and reduce thermal stress on components. The compressor is capable of operating on grades of at least 36.4 percent, corresponding to an angle of approximately 20 degrees from horizontal, while maintaining proper oil circulation and lubrication to prevent damage or excessive wear. A leveling system is provided to aid in setup and staging of the compressor on uneven surfaces, preferably including adjustable support legs, stabilizing jacks, or similar leveling mechanisms that allow operators to achieve acceptable operating orientation even on significantly sloped terrain.

Within the pod enclosure 202, ambient air is drawn through an intake filter assembly, compressed through the multiple compression stages of the four-stage compressor, and then directed through breathing air filtration and purification systems before being delivered to modular air storage cylinders 220 or directly to connected air hoses at connector ports 230 for immediate use. A telescoping pole assembly 250 is provided and is easily extended to elevate and suspend the compressor air intake filter at a height sufficient to ensure that only clean ambient air, free from engine exhaust contamination and ground-level particulates, is drawn into the compression system. The telescoping pole assembly 250 is configured such that the telescoping configuration allows the intake to be raised during operation and lowered for transport and storage. The compressor air intake filter is mountable on the extendable and retractable telescoping pole assembly 250, sometimes referred to as boom pole assembly 250, to allow the intake to be elevated above the enclosure during operation to draw clean air free from engine exhaust contamination, and retracted for transport to reduce overall height. The compressor intake system is configured with weatherproofing features including baffles, drainage provisions, and elevated positioning to prevent water ingress into the compression mechanism even during heavy precipitation.

The compressor provides breathable air directly to connector ports 230 for distribution to connected air distribution lines, or to onboard modular air cylinders 220 for storage and subsequent cascade filling operations. The connector ports 230 are positioned at locations on the pod enclosure 202 to allow for connection of air distribution lines for operational flexibility. The air compressor also provides low-pressure air output capability for the operation of pneumatic power tools, lifting bags, and other air-powered equipment commonly used in rescue and tactical operations. A breathing air filtration and purification system is configured to purify compressed air to meet Grade D breathing air quality standards as defined by the Compressed Gas Association. The breathing air produced by the system meets or exceeds Grade D breathing air quality standards, including requirements for maximum moisture content, maximum carbon monoxide content, maximum carbon dioxide content, maximum oil vapor content, and absence of objectionable odor. The breathing air filtration and purification system removes moisture, oil vapors, particulates, carbon monoxide, carbon dioxide, and other contaminants to ensure breathing air quality regardless of ambient air conditions or engine exhaust proximity. Additional filtration systems are provided for operation in hot humid climates where moisture content is elevated.

A separator assembly 270 is incorporated within the pod enclosure 202 for moisture and contaminant removal from the compressed air stream. The separator assembly 270 works in conjunction with the breathing air filtration system to ensure that moisture and liquid contaminants are removed before compressed air reaches the storage cylinders or distribution points. An automatic condensate drain system, referred to as ACD, is incorporated to automatically discharge accumulated moisture from the compression and purification process, preventing water accumulation that could lead to corrosion, contamination of breathing air, or system malfunction. The automatic condensate drain provides a means of automatically discharging condensate accumulation during operation from both the compressor system and the breathing air purification system, preventing moisture buildup that could compromise air quality or system performance.

An oil filter 272 is provided for maintaining engine lubrication system cleanliness, ensuring that the diesel engine 210 receives clean, filtered lubricating oil to prevent premature wear and extend engine service life. A fuel filter 274 is provided for removing contaminants from the diesel fuel supply before fuel reaches the injection system of the diesel engine 210. The fuel tank 260 is positioned on the upper surface 204 of the pod enclosure 202 for easy access and filling through an access door without requiring operators to access confined spaces or lower portions of the enclosure where components may be hot during operation or immediately following shutdown. Fuel capacity is sufficient to provide extended operation duration, preferably at least 8 to 12 hours of continuous operation, without requiring refueling. Dual fuel cell gauges are preferably positioned on opposite sides of the pod enclosure 202 to allow fuel level observation and monitoring from both sides of the unit, facilitating pre-operation checks and preventing inadvertent operation with insufficient fuel supply. The fuel gauges provide continuous monitoring of available fuel supply to prevent inadvertent depletion during operations.

Modular air cylinders 220 are disposed within the pod enclosure 202 and are secured by a bottle rack assembly 222. The bottle rack assembly 222 is configured to securely retain the modular air cylinders 220 during transport and operation while allowing for removal and replacement as needed. The modular air cylinders 220 are configured to store compressed breathing air at pressures up to approximately 6,000 pounds per square inch. The modular cylinder configuration allows cylinders to be removed and replaced individually if damaged or when reconfiguring capacity. Quick-connect fittings are provided on the modular air cylinders 220 to facilitate tool-free connection and disconnection, allowing rapid reconfiguration in the field without specialized tools.

A control panel 240 is positioned on the pod enclosure 202 to provide operational controls and system monitoring capabilities. The control panel 240 is preferably positioned on one side wall 263 of the pod enclosure 202, and optionally control panels may be positioned on both side walls 263 and 264 or at opposite ends of the pod cabinet to allow operators to connect air distribution lines and monitor system parameters from either side of the unit based on tactical positioning requirements or workflow efficiency considerations. The control panels incorporate emergency stop functionality, allowing immediate shutdown in the event of malfunction or hazardous conditions. Pressure gauges are provided on the control panel 240 to monitor both storage pressure and fill line pressure, allowing operators to verify proper system function and ensure SCBA cylinders are filled to required pressures. The pressure gauges monitor both high-pressure storage conditions, typically 6,000 pounds per square inch, and lower-pressure distribution conditions, typically 300 pounds per square inch for auxiliary equipment such as pneumatic tools.

Multiple lighting assemblies are incorporated into the pod enclosure 202 to support operations under various lighting conditions. A forward light 266, a center light 267, and a rear light 268 are provided to supply illumination for operation in low-light conditions. The system incorporates multiple types of lighting to support operations under various conditions including standard white illumination for normal operations and maintenance, low-intensity lighting for operations where excessive illumination would compromise operational security or interfere with night vision equipment, red lighting for maintaining dark adaptation of personnel while providing sufficient illumination for basic tasks, and infrared lighting compatible with night vision devices for completely covert operations where visible light emission is unacceptable. The specialized lighting configurations make the system suitable for tactical operations where concealment and operational security are paramount considerations.

Electrical power for control systems, lighting, and accessory equipment is provided by dual 12-volt DC batteries, preferably deep-cycle batteries suitable for repeated discharge and recharge cycles. An alternator or generator driven by the diesel engine 210 maintains battery charge during operation. A DC to AC inverter may be provided to allow charging of electronic devices, operation of AC-powered tools or equipment, or powering of communication equipment in field locations where other power sources are unavailable. Oil sump heating capability is provided for cold climate operations to ensure proper oil viscosity and flow during startup and operation at low ambient temperatures.

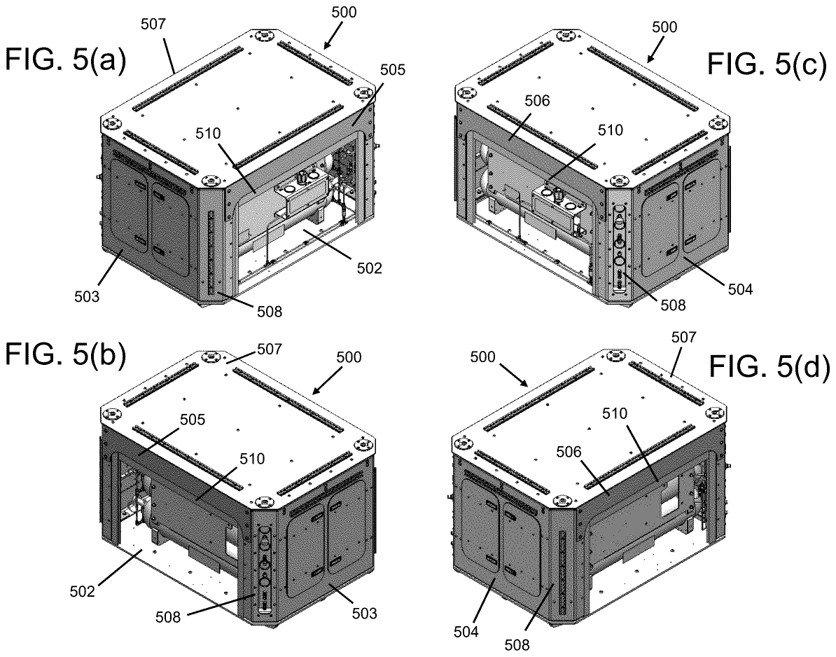

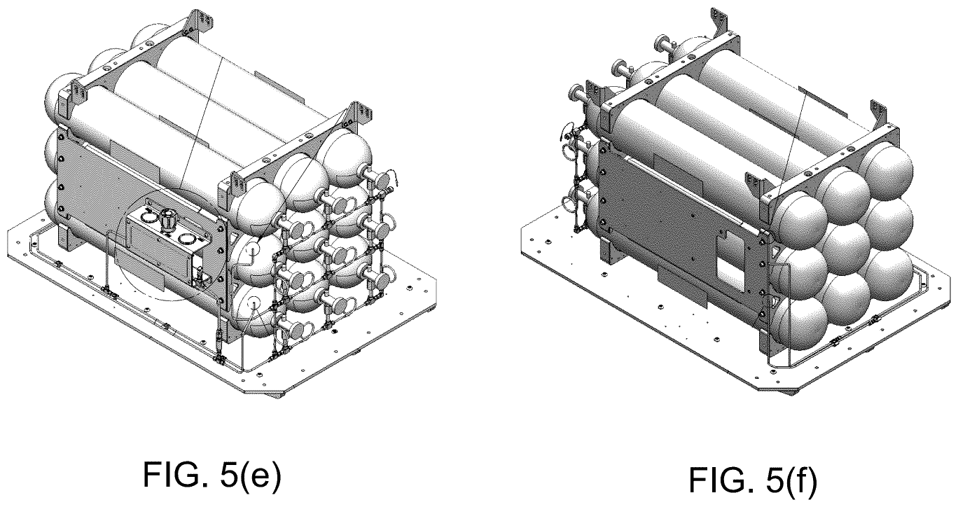

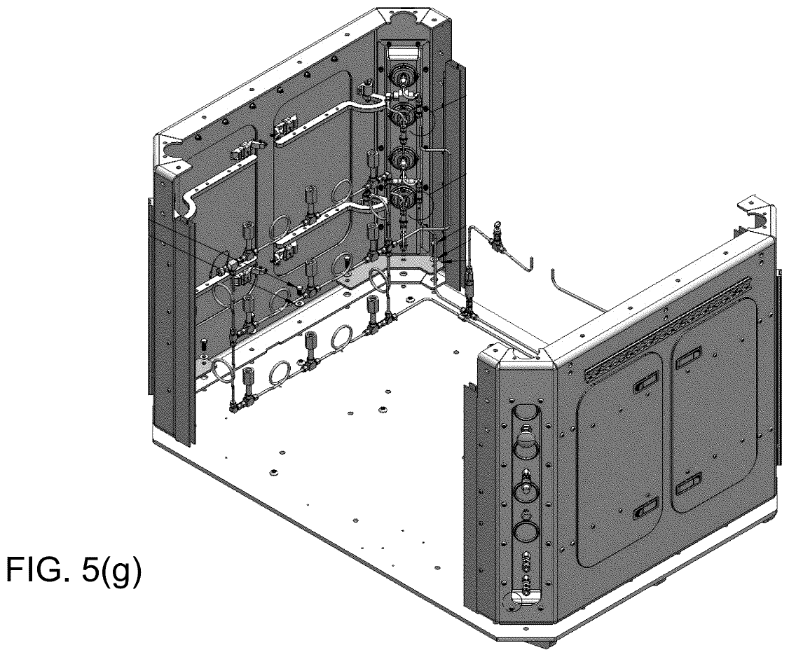

With reference to FIG. 5(a) through 5(g), the storage assembly 500 is configured as a separate modular unit from the air compressor and diesel engine module 200 and provides additional compressed air storage capacity. The storage assembly 500 comprises a base plate 502 providing structural foundation for the assembly. A first end wall 503 and a second end wall 504 are positioned at opposite ends of the storage assembly 500, and a first side wall 505 and a second side wall 506 are positioned at opposite sides of the storage assembly 500. A roof assembly 507 provides weather protection for the storage assembly 500. Top plate stiffeners provide structural reinforcement across the roof assembly 507. Corner plates 508 are provided at the corners of the storage assembly 500 for structural reinforcement. Rolling doors 510, preferably rollok-style doors, are provided on the storage assembly 500 to provide access to internal components. Rolling door housings contain the mechanisms for the rolling doors 510.

The storage assembly 500 houses a bottle plumbing system 520 that interconnects the individual modular storage cylinders and provides connection to the compressor output and distribution systems. The bottle plumbing system 520 comprises tubing connections that route compressed air between cylinders and from the cylinders to the distribution system. The modular storage configuration allows cylinders to be removed and replaced individually if damaged or when reconfiguring capacity, with quick-connect fittings facilitating tool-free connection and disconnection. A control panel 522 is provided on the storage assembly 500 to allow distribution of air from the modular cylinders 220 housed within the storage assembly 500. Pressure gauges are installed on the control panel 522 to monitor both high-pressure storage conditions and lower-pressure distribution conditions. The storage cylinder modules are configured as individually packaged storage cylinders for modularity, portability, and scalability. For added portability, a structural frame may surround one or more storage cylinders and provide protection and facilitate handling. Detachable wheels are configured to facilitate transportation of the structural frame and repositioning without requiring lifting equipment. The modular storage cylinder configuration allows the total storage capacity to be adjusted based on mission requirements, with cylinders added or removed as needed to balance system weight against operational endurance.

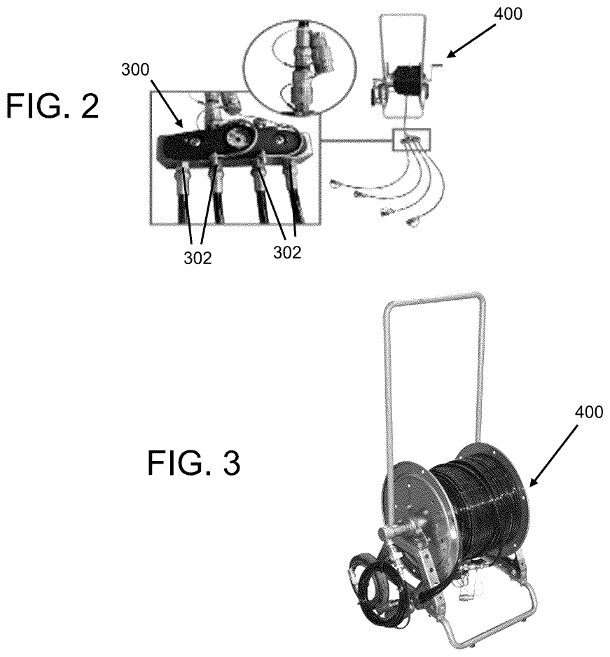

With reference to FIG. 2, the distribution manifold 300 is fluidly connected to the modular air storage cylinders 220 and provides the interface for simultaneous refilling of multiple SCBA cylinders. The distribution manifold 300 has preferably four high-pressure outlet connections 302, sometimes referred to as whips, configured for simultaneous connection to four self-contained breathing apparatus cylinders to enable simultaneous refilling of at least four SCBA cylinders. Each outlet connection 302 is configured for connection to a self-contained breathing apparatus cylinder. The distribution manifold 300 allows for flash fill of air cylinders by providing parallel flow paths from the storage cylinder bank to multiple SCBA cylinders undergoing refilling, thereby maximizing flow rate and minimizing fill time. The distribution manifold 300 is compatible with appropriate refill hose and connector fittings to provide compatibility with United States military standard SCBA equipment and Israeli standard SCBA equipment, ensuring interoperability in combined operations or when supporting allied forces. Flow restrictions between the compressor output, the storage cylinder bank, and the SCBA cylinders undergoing refilling are minimized through properly sized tubing, fittings, and manifold internal passages to maximize charge rate and minimize fill time.

With reference to FIG. 3, the hose reel system 400 is configured to support an extended-length hose having a length of at least 500 feet. The extended-length hose is fluidly connected to the distribution manifold 300 and is configured to deliver compressed breathing air at distances up to at least 500 feet from the system while maintaining delivery pressure of at least 6,000 pounds per square inch at the terminal end. One or more hose reel systems 400 are provided for distribution of high-pressure breathing air up to 500 feet or more from the trailer-mounted or stationary position of the compression and storage system. The hose reel system 400 preferably includes a hitch mount configuration that allows the hose reel to be positioned separately from the air compressor and diesel engine module 200 and the storage assembly 500. The distribution manifold 300 with four high-pressure outlet connections 302 is positioned at the terminus of the extended hose to allow simultaneous refilling operations at the remote location. The extended hose capability is critical for tactical operations where the compressor and storage system must be positioned in a secure or concealed location while refilling operations occur at a forward position, or where noise from compressor operation would compromise operational security. One or more 500-foot hose reel assemblies may be detachably mounted on the AWAJ system 100 for ease of transport.

The materials used in construction of the enclosure, frame components, and structural elements are selected for durability, corrosion resistance, and weight optimization. Aluminum alloys are preferably used for many structural components to minimize weight while providing adequate strength. Stainless steel fasteners and components are used in critical areas and where exposure to moisture and corrosion is likely. Protective coatings and finishes are applied to surfaces to resist corrosion, abrasion, and environmental degradation. Seals and gaskets are configured from materials suitable for the operating temperature range and resistant to degradation from exposure to petroleum products, moisture, and environmental contaminants.

The AWAJ system 100 is preferably configured to provide air delivery at a volumetric flow rate of approximately 22.5 cubic feet per minute, corresponding to approximately 637 liters per minute at standard conditions. The system is configured to provide total air storage capacity of approximately 94 liters measured at uncompressed atmospheric conditions, which corresponds to approximately 31,351 liters of air volume when compressed to 6,000 pounds per square inch storage pressure. The system is configured to rapidly fill, sometimes referred to as flash fill, air cylinders in less than 5 minutes measured from a depleted starting pressure to full 6,000 pounds per square inch operating pressure, with this 5-minute requirement representing a threshold minimum performance requirement, and preferably the system achieves fill times within approximately 1.5 minutes representing an objective performance target for optimal operational effectiveness. The term threshold as used herein refers to the minimum acceptable performance requirement that the system is configured to meet, while the term objective refers to the desired or ideal performance parameters that provide enhanced operational capability. The system is configured to fill SCBA air cylinders to a minimum distance of 500 feet from the system staging area utilizing extension hoses as a threshold requirement, and preferably the system is likewise configured to flash fill air cylinders to a minimum distance of 500 feet from the system staging area utilizing extension hoses as an objective performance characteristic. The system is configured to rapidly refill up to a minimum of four 9-liter SCBA air cylinders simultaneously to operating pressures of 6,000 pounds per square inch, which corresponds to approximately 413.7 bar pressure.

The AWAJ system 100 is preferably configured to meet Military Standard 810H requirements for operation in rain, spray, and dripping water conditions, temperature extremes and impact shock encountered during air drop operations, and various climatic conditions including cold, hot-dry, and hot-humid environmental profiles. The system is configured to meet Military Standard 810H requirements for operating in rain, water spray, or dripping water during continuous uninterrupted operation and without introducing contaminants into the breathing air supplied to cylinders. The system is configured to provide Grade D or better breathing air quality before, during, and after exposure to rain and blowing wind conditions. The system is configured to meet Military Standard 810H requirements for temperature extremes, shock loading, and impact forces encountered during air drop operations, achieved at least in part through the system enclosure configured to withstand impact and shock requirements specified in the standard. Structural reinforcement, shock-absorbing mounting systems, and protective frameworks are incorporated into the pod enclosure 202 and storage assembly 500 to protect vulnerable components during parachute deployment, descent, and ground impact. The system is configured to meet weight and volume constraints established for fixed-wing or rotary-wing air transport and is capable of sustaining low-altitude air drop insertion with parachute deployment. The shock resistance and impact tolerance designed into the system ensure that functionality is maintained following air drop deployment. The air drop capability enables rapid deployment by military airlift in situations where ground transportation would be too slow or where ground access routes are unavailable or contested. The system can be parachute-deployed along with personnel and other equipment, allowing complete operational capability to be established in remote or forward locations without requiring ground supply lines.

The AWAJ system 100 is capable of transport over unimproved road and off-road conditions without suffering damage to components or loss of operational capability, and the system is configured to function across the full range of climatic condition profiles including cold environments with sub-freezing temperatures, hot-dry desert environments with extreme high temperatures and low humidity, and hot-humid tropical environments with elevated temperatures combined with high moisture content. The system is configured for setup and operation on uneven and rough terrain commonly encountered in field deployment locations. The weather resistance features enable continuous operation during precipitation events that would render conventional systems inoperable or would require operational shutdown to prevent moisture contamination of breathing air supplies. This capability eliminates weather-dependent operational planning constraints and allows missions to proceed regardless of forecast conditions. The ability to operate on uneven terrain eliminates the need to prepare level staging areas or transport additional leveling equipment, reducing setup time and logistical burden.

The extended hose capability allows the compressor and storage system to be positioned at a secure location, potentially in a concealed position or behind protective barriers, while refilling operations occur at forward positions where personnel are working, thereby enhancing operational security and personnel safety. The compatibility with standard military vehicles for towing, standard electrical connections for integration with vehicle electrical systems, and standard SCBA fittings for interoperability with existing equipment inventories eliminates the need for specialized adapters, custom components, or extensive integration efforts, allowing the system to be rapidly deployed and utilized by military units, first responder organizations, and other users with minimal training and preparation time. The modular design with quick-connect fittings and tool-free assembly features allows the system to be disassembled, transported, and reassembled by operators in the field without requiring specialized technical training or tools beyond basic hand tools commonly available in military and first responder units.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

What is claimed is:

1. A portable air delivery system for refilling self-contained breathing apparatus cylinders, comprising:
an enclosure assembly defining an interior volume;
a four-stage breathing air compressor disposed within the interior volume;
a diesel engine operatively connected to the compressor and configured to drive the compressor;
a plurality of modular air storage cylinders configured to store compressed breathing air at pressures up to approximately 6,000 pounds per square inch;
a distribution manifold fluidly connected to the air storage cylinders and having a plurality of high-pressure outlet connections, each outlet connection configured for connection to a self-contained breathing apparatus cylinder to enable simultaneous refilling of a plurality of self-contained breathing apparatus cylinders;
a hose reel assembly configured to support an extended-length hose having a length of at least 500 feet, the extended-length hose fluidly connected to the distribution manifold and configured to deliver compressed breathing air at distances up to at least 500 feet from the system; and
a mobile trailer platform having a frame and a hitch assembly;
wherein the enclosure assembly, the compressor, the engine, and the air storage cylinders are removably mounted to the mobile trailer platform in a modular configuration such that the enclosure assembly, the compressor, the engine, and the air storage cylinders can be individually removed from the trailer platform and reassembled for operation without the trailer platform;
wherein the enclosure assembly includes weatherproofing features comprising weather-resistant electrical components and a weatherproofed compressor intake system to enable operation during rain and water spray conditions while maintaining breathing air quality standards; and
wherein the system has a total weight not exceeding 10,000 pounds and dimensions not exceeding 180 inches in width and 88 inches in length.

2. The system of claim 1, further comprising a leveling system configured to stabilize the compressor on uneven terrain, wherein the compressor is capable of operating on grades of at least 36.4 percent while maintaining proper lubrication.

3. The system of claim 1, wherein:
the compressor is configured to provide air delivery at a rate of approximately 22.5 cubic feet per minute; and
the plurality of modular air storage cylinders provide a total air storage capacity of approximately 94 liters at atmospheric pressure, corresponding to approximately 31,351 liters at 6,000 pounds per square inch.

4. The system of claim 1, wherein the system is configured to fill a self-contained breathing apparatus cylinder from depleted pressure to 6,000 pounds per square inch in less than 5 minutes at a distance of up to 500 feet from the system, and wherein the system is configured to fill a self-contained breathing apparatus cylinder from depleted pressure to 6,000 pounds per square inch in approximately 1.5 minutes as an objective performance target.

5. The system of claim 1, further comprising an automatic condensate drain system configured to automatically discharge accumulated moisture from the compressor and air purification system during operation.

6. The system of claim 1, further comprising a telescoping pole assembly configured to support an air intake filter, the telescoping pole assembly being extendable to elevate the air intake filter above the enclosure assembly to draw clean air free from engine exhaust contamination.

7. The system of claim 1, wherein:
the enclosure assembly includes dual rolling door assemblies positioned on opposite side walls of the enclosure to provide access to internal components from either side; and
the system includes at least one control panel positioned on the enclosure assembly and configured to allow connection of air distribution lines and monitoring of system parameters.

8. The system of claim 1, wherein the hitch assembly includes a pintle-style receiver hitch and an electrical wire harness.

9. The system of claim 1, wherein the modular air storage cylinders include quick-connect fittings configured to allow tool-free connection and disconnection of individual cylinders.

10. The system of claim 1, further comprising:
a fuel tank positioned on an upper surface of the enclosure assembly; and
dual fuel gauges positioned on opposite sides of the enclosure assembly to allow fuel level observation from both sides.

11. A modular air compression system for field operations, comprising:
a pod enclosure having a base plate assembly, sidewall assemblies, and a roof assembly;
a four-stage compressor disposed within the pod enclosure and configured to compress ambient air to pressures of at least 6,000 pounds per square inch;
a direct-injection diesel engine mounted within the pod enclosure and operatively coupled to drive the compressor;
a breathing air filtration system configured to purify compressed air;
a storage assembly separate from the pod enclosure and comprising:
a plurality of individually packaged storage cylinders configured for modular arrangement, each storage cylinder having a quick-connect fitting; and
a structural frame surrounding the storage cylinders;
a distribution manifold having a plurality of high-pressure outlet whips configured for simultaneous connection to a plurality of self-contained breathing apparatus cylinders; and
an extended-length hose system comprising a hose reel and a hose having a length of at least 500 feet, the hose configured to maintain delivery pressure of at least 6,000 pounds per square inch at the terminal end;
wherein the compressor is configured to operate on terrain having a grade of at least 36.4 percent.

12. The system of claim 11, further comprising adjustable support legs configured to level the pod enclosure on uneven terrain to maintain proper oil circulation within the compressor.

13. The system of claim 11, wherein:
the enclosure includes an integrated canopy structure configured to protect components from precipitation;
the electrical components include sealed connectors and protected wiring routing; and
the compressor intake system includes baffles and drainage provisions to prevent water ingress.

14. The system of claim 11, further comprising:
additional filtration configured for operation in hot humid climates; and
oil sump heating capability configured to ensure proper oil viscosity during startup in cold climates.

15. The system of claim 11, further comprising a telescoping boom pole assembly configured to elevate the compressor air intake filter above the pod enclosure during operation and retract for transport.

16. The system of claim 11, wherein the breathing air filtration system is configured to remove moisture, oil vapors, particulates, carbon monoxide, and carbon dioxide to ensure breathing air quality.

17. The system of claim 11, further comprising:
dual 12-volt DC batteries configured to provide electrical power; and
a DC to AC inverter configured to allow charging of electronic devices.

18. The system of claim 11, further comprising:
multiple lighting assemblies including standard white illumination, low-intensity lighting, red lighting, and infrared lighting compatible with night vision devices.

19. A method of providing compressed breathing air to self-contained breathing apparatus cylinders in field conditions, comprising:
transporting a modular air delivery system to a field location, the system comprising:
an enclosure assembly housing a four-stage compressor and a diesel engine;
a plurality of modular storage cylinders;
a distribution manifold having a plurality of outlet connections; and
an extended-length hose of at least 500 feet;
positioning the modular air delivery system at a first location;
deploying the extended-length hose from the first location to a second location at least 500 feet from the first location;
leveling the compressor on uneven terrain;
operating the diesel engine to drive the compressor;
compressing ambient air to at least 6,000 pounds per square inch and storing the compressed air in the modular storage cylinders;
simultaneously connecting a plurality of self-contained breathing apparatus cylinders to the plurality of outlet connections of the distribution manifold at the second location;
transferring compressed air from the modular storage cylinders through the extended-length hose to the distribution manifold; and
filling the plurality of self-contained breathing apparatus cylinders to 6,000 pounds per square inch in less than 5 minutes while operating in at least one of rain conditions, water spray conditions, and dripping water conditions.

20. The method of claim 19, further comprising:
removing the enclosure assembly, the compressor, the engine, and the modular storage cylinders from a trailer platform;
redistributing the removed components among multiple tactical vehicles;
transporting the components to a deployment location; and
reassembling the components for operation without the trailer platform.

21. The system of claim 1, wherein the compressor is configured to provide compressed air output at multiple pressure levels including:
a high-pressure output at approximately 6,000 pounds per square inch configured for self-contained breathing apparatus cylinder refilling; and
a low-pressure output at approximately 300 pounds per square inch configured for operation of pneumatic tools and rescue equipment.

22. The system of claim 1, wherein the system is configured for cascade filling operations whereby compressed air stored in the modular air storage cylinders is transferred to self-contained breathing apparatus cylinders through the distribution manifold without continuous compressor operation during the transfer.

23. The system of claim 11, wherein the pod enclosure includes dual rolling door assemblies positioned on opposite side walls of the pod enclosure configured to provide bilateral access to internal components for maintenance and operational activities from either side of the system.

24. The system of claim 1, wherein the distribution manifold and extended-length hose are configured with connector fittings compatible with both United States military standard self-contained breathing apparatus equipment and Israeli standard self-contained breathing apparatus equipment to enable interoperability in combined operations.
